(19) United States
(12) Patent Application Publication
(10) Pub. No.: US 2013/0062815 A1
(43) Pub. Date: Mar. 14, 2013

(54) ELECTROMAGNETICALLY ABSORBING COMPOSITION AND MANUFACTURING METHOD THEREOF

(71) Applicant: R.O.C. Military Academy, Kaohsiung (TW)

(72) Inventor: Tzu-Hao TING, Kaohsiung (TW)

(73) Assignee: R.O.C. MILITARY ACADEMY, Kaohsiung (TW)

(21) Appl. No.: 13/672,387

(22) Filed: Nov. 8, 2012

Related U.S. Application Data
(62) Division of application No. 13/110,258, filed on May 18, 2011.

(51) Int. Cl. B29C 39/02

(52) U.S. Cl. CPC B29C 39/02
USPC 264/334

(57) ABSTRACT

An electromagnetically absorbing composition and a manufacturing method thereof are provided. The manufacturing method includes steps of: a) 40 wt %-80 wt % of a fluid resin and 20 wt %-60 wt % of coffee grounds; b) mixing the fluid resin and the coffee grounds into homogeneous slurry through a mixing process; c) placing the slurry into a mold assembly; d) after curing and cooling, removing from the mold assembly the composition of a thickness of 0.5 mm-5.0 mm, with a reflection loss above 10 dB from 2 to 18 GHz.

### CROSS-REFERENCE TO RELATED APPLICATIONS

This application is a Divisional of the pending U.S. patent application Ser. No. 13/110,258 filed on May 18, 2011, all of which is hereby incorporated by reference in its entirety.

Although incorporated by reference in its entirety, no arguments or disclaimers made in the parent application apply to this divisional application. Any disclaimer that may have occurred during the prosecution of the above-referenced application(s) is hereby expressly rescinded. Consequently, the Patent Office is asked to review the new set of claims in view of the entire prior art of record and any search that the Office deems appropriate.

### BACKGROUND OF THE INVENTION

1. Technical Field

The present invention relates to electromagnetically absorbing compositions, and more particularly, to an electromagnetically absorbing composition made of recovered coffee grounds through a simple process so as to eliminate the use of chemically synthesized compounds such as conductive carbon black, carbon powder, conductive fiber, graphite, carbon nanocapsules and so on. The disclosed electromagnetically absorbing composition is thereby environmentally friendly and economic.

2. Description of Related Art

Taiwan Patent No. 469283 has taught a method for preparing a dielectric electromagnetically absorbing material, which involves adding conductive carbon black, carbon powder, conductive fiber and microballoons in fluid polyurethane (PU) resin, mixing the above into a slurry-like semi-finished product by a special two-stage mixer, and molding the semi-finished product into the dielectric electromagnetically absorbing material with desired shape. Taiwan Patent No. 567643 has disclosed an improved Salbury-Screen type electromagnetically absorbing material, which has a layer of harmonious loss material and a layer of low-k material, plus a reflective layer. Taiwan Patent No. 566077 has proposed a resin-based electromagnetic absorbent made from 5-50 wt % of multilayer hollow carbon balls in the resin. Taiwan Patent Application Publication No. 200605772 has disclosed an extrudable crosslinked grease-like electromagnetic waves absorbent. U.S. Pat. No. 6,465,098B2 has provided an electromagnetic wave absorbing material comprising a carbon black in 5 to 10 parts by weight and a gas phase growth carbon fiber in 1 to 10 parts by weight instead of the traditional carbon fiber that are mixed well in a resin based on 100 parts by weight of the resin. The electromagnetic wave absorbing material can then be made into sheet with different levels of thickness.

However, each of the above-mentioned known technologies has its shortcomings and problems.

In the method for preparing the dielectric electromagnetically absorbing material as disclosed in Taiwan Patent No. 469283, some carbon blacks are first mixed with and distributed over the resin by using a high speed mixer working at 3000-6000 rpm, and then more carbon powder, conductive fiber and hollow balls are added. At this time, the slurry has its thickness significantly increased, and can only be mixed with a low-speed mixer for high viscosity working at 300-600 rpm so that the slurry can have the substances distributed evenly to produce the dielectric electromagnetically absorbing material that is later shaped into sheets. The overall process and apparatuses involved are complicated, and the used conductive stuff is entirely formed from chemically synthesized compounds, being adverse to the trend toward environmental protection in the industry. The improved Salbury-Screen type electromagnetically absorbing material of Taiwan Patent No. 567643 has a composite structure formed from a layer of harmonious loss material and a layer of low-k material, thus requires a relatively complex manufacturing process. U.S. Pat. No. 6,465,098B2 uses a gas phase growth carbon fiber instead of the traditional carbon fiber. Although this scheme is useful in reducing the use of carbon black and carbon fiber, the used conductive stuff is totally from chemically synthesized compounds, also being adverse to the trend toward environmental protection in the industry. In the resin-based electromagnetic absorbent of Taiwan Patent No. 566077, the multilayer hollow carbon balls taking 5-50 wt % in the absorbent are also a kind of chemically synthesized compounds, so is also adverse to the trend toward environmental protection in the industry.

### SUMMARY OF THE INVENTION

In view of the above problems, the present invention provides an environmentally friendly, electromagnetically absorbing composition and a manufacturing method thereof. The present invention uses waste coffee grounds recovered by filtering milled and brewed natural coffee beans as the active material of the electromagnetically absorbing composition, so as to save material costs and preserve resources by reusing waste, thus causing the disclosed composition to be favorable to environmental protection and sustainable use.

The environmentally friendly, electromagnetically absorbing composition as disclosed is mainly composed of 40 wt %-80 wt % of a binding agent and 20 wt %-60 wt % of coffee grounds based on a total weight of the composition. The composition is preferably shaped into a sheet having a thickness of 0.5 mm-5.0 mm, with a reflection loss above 10 dB in a frequency range from 2 to 18 GHz.

The environmentally friendly, electromagnetically absorbing composition may be prepared through the method described below:

a) preparing 40 wt %-80 wt % of a fluid resin and 20 wt %-60 wt % of coffee grounds based on a total weight of the composition;

b) mixing the fluid resin and the coffee grounds into homogeneous slurry through a mixing process;

c) placing the homogeneous slurry into a mold assembly;

d) after curing and cooling, removing the composition from the mold assembly as a sheet of the environmentally friendly, electromagnetically absorbing composition having a thickness of 0.5 mm-5.0 mm, with a reflection loss above 10 dB in a frequency range from 2 GHz to 18 GHz.

The present invention features using waste coffee grounds recovered by filtering milled and brewed natural coffee beans as the active material of the electromagnetically absorbing composition, so as to save material costs and preserve resources by reusing waste, thus causing the disclosed composition to be favorable to environmental protection and sustainable use while having excellent electromagnetically absorbing capability.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 displays a profile of reflection loss of a material made according to a first example of the present invention;

FIG. 2 displays a profile of reflection loss of a material made according to a second example of the present invention;

FIG. 3 displays a profile of reflection loss of a material made according to a third example of the present invention;

FIG. 4 displays a profile of reflection loss of a material made according to a fourth example of the present invention;

FIG. 5 displays a profile of reflection loss of a material made according to a fifth example of the present invention;

FIG. 6 displays a profile of reflection loss of a material made according to a sixth example of the present invention; and

FIG. 7 is a flowchart of a manufacturing method provided by the present invention.

### DETAILED DESCRIPTION OF THE INVENTION

For clarifying the principles and features of the present invention, the theoretical basis of the present invention is first discussed in brief.

When a plane electromagnetic wave is forward propagated through the air to an electromagnetically absorbing material provided with a conductive metal layer at its back, the reflection coefficient of the electromagnetic wave at the interface between the air and the material can be expressed through the following equation:

$$ρ = \frac{{Z}_{2} tanh ( {γ}_{2} {d}_{2} ) - {Z}_{1}}{{Z}_{2} tanh ( {γ}_{2} {d}_{2} ) + {Z}_{1}} \qquad ( 1 )$$

while the reflection loss dB can be defined through the following equation:

ρ(dB)=10 log(|ρ|²) (2)

In Equation 1, letters suffixed by 1 are associated to the air and letters suffixed by 2 are associated to the absorbing material, while p represents the reflection coefficient, namely a ratio between the power of the reflected wave to the power of the incident wave, d₂ is the thickness of the absorbing material, and γ₂ is the propagation coefficient of the electromagnetic wave in the absorbing material, wherein the propagation coefficient is expressed as:

γ₂=\sqrt{−w²∈₂μ₂} (2)

Z₁ and Z₂ are impedance values of the air and of the absorbing material, respectively:

$$\begin{matrix}{Z}_{1} = {Z}_{0} = \sqrt{\frac{{μ}_{0}}{{ɛ}_{0}}} = 377 Ω & ( 4 ) \\ {Z}_{2} = \sqrt{\frac{{μ}_{2}}{{ɛ}_{2}}} & ( 5 )\end{matrix}$$

where ∈ and μ are the dielectric coefficient and the permeance coefficient of the material, respectively. Since the absorbing material exhibits electrical polarization in the electromagnetic field, and the reaction is with time delay, meaning that there is loss, the dielectric coefficient ∈ᵣ and the relative permeance coefficient μᵣ of the absorbing material with respect to the air are typically expressed in a complex form:

$$\begin{matrix}{ɛ}_{r} = \frac{{ɛ}_{2}}{{ɛ}_{o}} = \frac{{ɛ}_{2}^{′} - {jɛ}_{2}^{″}}{{ɛ}_{o}} = {ɛ}_{r}^{′} - {jɛ}_{r}^{″} & ( 6 ) \\ {μ}_{r} = \frac{{μ}_{2}}{{μ}_{o}} = \frac{{μ}_{2}^{′} - {jμ}_{2}^{″}}{{μ}_{o}} = {μ}_{r}^{′} - {jμ}_{r}^{″} & ( 7 )\end{matrix}$$

For zero reflection, from Equation (1), it is obtained that:

Z₂ tan h(γ₂d₂)−Z₁=0 (8)

Therefore, for obtaining the optimal absorbing material, the conductive or permeable material and its content have to be carefully selected with the thickness of the material properly controlled.

The environmentally friendly, electromagnetically absorbing composition of the present invention may be prepared by adding coffee grounds as stuff in a fluid resin, mixing them with a conventional three roll mill (the interval between its rolls is 0.1 mm) into uniform slurry, pouring the slurry into a metal mold sized 15 cm×15 cm covered above and below with aluminum boards that are clipped to the mold, heating the mold at 80° C. for 2 hours, making the slurry in the mold cooled, uncovering the mold and removing the cured resin with the coffee grounds from the mold. The cured resin in the shape of a sheet is measured for its thickness and weight. Alternatively, rubber instead of the resin may be used as the binding agent for binding the stuff, coffee grounds. The materials are mixed in a double-roll mixer for 10-20 cycles, then shaped by a sheeter, cut into crude rubber sheets of a desired size, and molded and pressurized in a mold for being cured. The cured sheet is trimmed as the finished electromagnetically absorbing material.

The free-space method may be employed for measuring the reflection loss of a microwave at 2-18 GHz. In measurement, a vector network analyzer HP 8722ES and free space setups of Damaskos, Inc. are used. A metal sheet sized 15 cm×15 cm, as large as the specimen bar, is placed onto the measuring site. After calibration of levelness, the antenna is such adjusted that the angle of arrival is 21° for measuring the original reflection. Then the specimen bar is installed with the metal sheet as a reflective surface for measuring the reflection loss caused by the specimen.

For further illustrating the present invention, certain examples will be given below without limiting the scope of the present invention.

### Example 1

70.0 g of a liquid epoxy resin and 30.0 g of coffee grounds were placed into a 250 ml mixing container (the batch weighting 100 g in total, the same in the following examples).

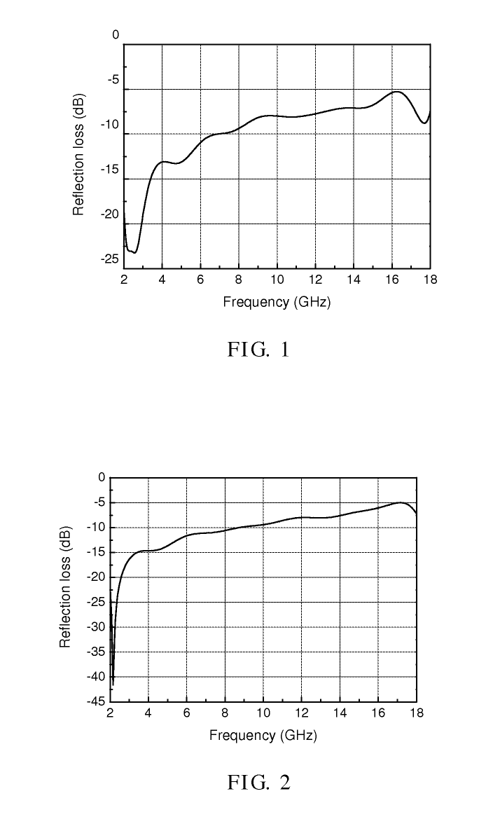

The batch was mixed first by a stirring rod for 1-5 minutes, and then by a three roll mill for 5 cycles until even slurry was obtained. 53.0 g of the slurry was weighted and poured into a metal mold sized 15 cm×15 cm. The slurry in the mold was cured into a specimen sheet. The specimen sheet was trimmed and measured as have a weight of 50.92 g and a thickness of 2.0 mm, with its weight per unit area of 2.26 Kg/m×m. The microwave reflection loss measured is reflected in FIG. 1, with a peak value of 23.5 dB at 2.5 GHz.

### Example 2

60.0 g of a liquid epoxy resin and 40.0 g of coffee grounds were placed into a 250 ml mixing container. The batch was mixed first by a stirring rod for 1-5 minutes, and then by a three roll mill for 5 cycles until even slurry was obtained. 55.0 g of the slurry was weighted and poured into a metal mold sized 15 cm×15 cm. The slurry in the mold was cured into a specimen sheet. The specimen sheet was trimmed and measured as have a weight of 52.7 g and a thickness of 2.0 mm, with its weight per unit area of 2.34 Kg/m×m. The microwave reflection loss measured is reflected in FIG. 2, with a peak value of 40 dB at 2.3 GHz.

### Example 3

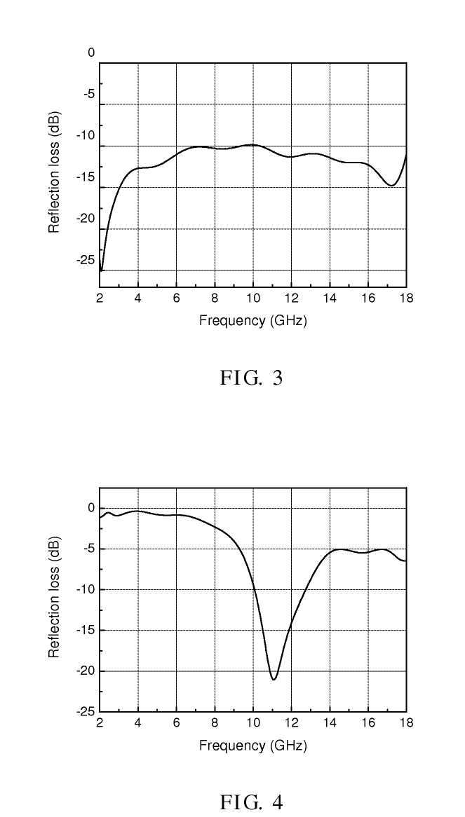

50.0 g of a liquid epoxy resin and 50.0 g of coffee grounds were placed into a 250 ml mixing container. The batch was mixed first by a stirring rod for 1-5 minutes, and then by a three roll mill for 5 cycles until even slurry was obtained. 55.0 g of the slurry was weighted and poured into a metal mold sized 15 cm×15 cm. The slurry in the mold was cured into a specimen sheet. The specimen sheet was trimmed and measured as have a weight of 53.1 g and a thickness of 2.0 mm, with its weight per unit area of 2.36 Kg/m×m. The microwave reflection loss measured is reflected in FIG. 3, with a peak value of 25 dB at 2.1 GHz.

### Example 4

Slurry was made with the formula in the way as used in Example 3. 82.0 g of the slurry was weighted and molded into a specimen sheet having a weight of 79.7 g and a thickness of 3.0 mm, with its weight per unit area of 3.5 Kg/m×m. The microwave reflection loss measured is reflected in FIG. 4, with a peak value of 19.0 dB at 11.1 GHz.

### Example 5

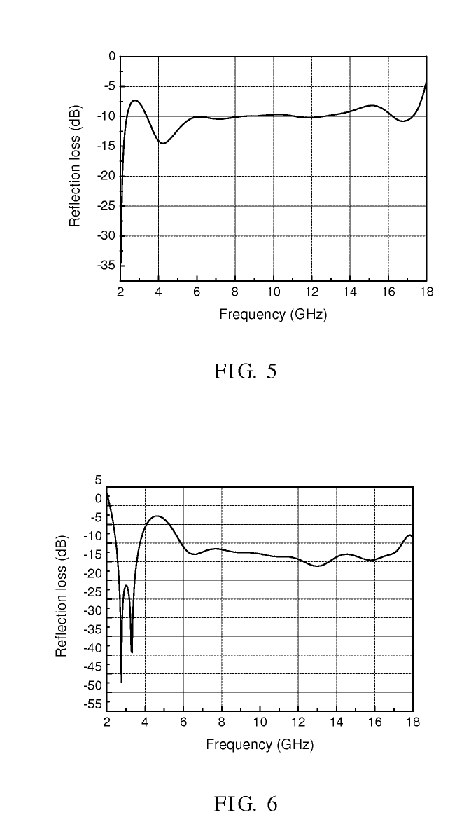

40.0 g of a liquid epoxy resin and 60.0 g of coffee grounds were placed into a 250 ml mixing container. The batch was mixed first by a stirring rod for 1-5 minutes, and then by a three roll mill for 5 cycles until even slurry was obtained. 75.0 g of the slurry was weighted and poured into a metal mold sized 15 cm×15 cm. The slurry in the mold was cured into a specimen sheet. The specimen sheet was trimmed and measured as have a weight of 72.5 g and a thickness of 2.0 mm, with its weight per unit area of 3.2 Kg/m×m. The microwave reflection loss measured is reflected in FIG. 5, with a peak value of 18.0 dB at 5.2 GHz.

### Example 6

30.0 g of a liquid epoxy resin and 70.0 g of coffee grounds were placed into a 250 ml mixing container. The batch was mixed first by a stirring rod for 1-5 minutes, and then by a three roll mill for 5 cycles until even slurry was obtained. 85.0 g of the slurry was weighted and poured into a metal mold sized 15 cm×15 cm. The slurry in the mold was cured into a specimen sheet. The specimen sheet was trimmed and measured as have a weight of 84.5 g and a thickness of 2.0 mm, with its weight per unit area of 3.7 Kg/m×m. The microwave reflection loss measured is reflected in FIG. 6, with a peak value of 50 dB at 2.8 GHz.

The environmentally friendly, electromagnetically absorbing composition of the present invention is mainly composed of a binding agent of 40 wt %-80 wt % and coffee grounds of 20 wt %-60 wt %. The composition is preferably to be shaped with a thickness of 0.5 mm-5.0 mm, and features causing a reflection loss above 10 dB in a frequency range from 2 GHz to 18 GHz. According to a preferred embodiment, the coffee grounds takes 40 wt %-55 wt % in the composition and the composition is shaped to have a thickness of 1.0 mm-3.0 mm.

Therein, the coffee grounds are waste coffee grounds recovered by filtering milled and brewed coffee beans. The binding agent is a fluid resin, such as epoxy resin, polyurethane resin, poly-methyl methacrylate resin, silicon resin or polyester resin.

Furthermore, the binding agent may be natural rubber or synthetic rubber that may be butadiene rubber, styrene-butadiene rubber, ethylene-propylene rubber, butyl rubber, chlorinated butyl rubber, chloroprene rubber or silicone rubber.

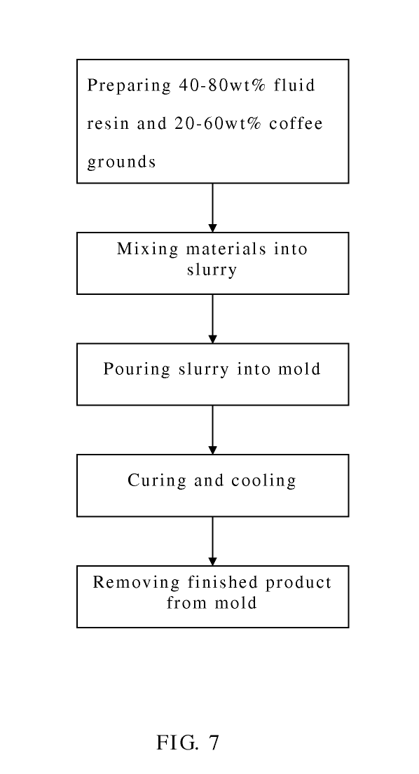

Referring to FIG. 7, the present invention further provides a manufacturing method of an environmentally friendly, electromagnetically absorbing composition. The manufacturing method comprises the following steps:

a) preparing 40 wt %-80 wt % of a fluid resin and 20 wt %-60 wt % of coffee grounds based on a total weight of the composition;

b) mixing the fluid resin and the coffee grounds into homogeneous slurry through a mixing process where a three roll mill is used;

c) placing the homogeneous slurry into a mold assembly;

d) after curing and cooling, removing the composition from the mold assembly as a sheet of the environmentally friendly, electromagnetically absorbing composition having a thickness of 0.5 mm-5.0 mm, with a reflection loss above 10 dB in a frequency range from 2 GHz to 18 GHz.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for manufacturing an electromagnetically absorbing composition, the method comprising steps of:
a) preparing 40 wt %-80 wt % of a fluid resin and 20 wt %-60 wt % of coffee grounds based on a total weight of the composition;
b) mixing the fluid resin and the coffee grounds into homogeneous slurry through a mixing process;
c) placing the homogeneous slurry into a mold assembly; and
d) after curing and cooling, removing the composition from the mold assembly as a sheet of the environmentally friendly, electromagnetically absorbing composition having a thickness of 0.5 mm-5.0 mm, with a reflection loss above 10 dB in a frequency range from 2 GHz to 18 GHz.

2. The method of claim 1, wherein the mixing process comprises using a three roll mill to mix the fluid resin and the coffee grounds into the homogeneous slurry.
